(19) United States
(12) Patent Application Publication
(10) Pub. No.: US 2022/0022578 A1
(43) Pub. Date: Jan. 27, 2022

(54) CONJOINED HAND WEAR

(71) Applicant: Stephanie Ann Highkin, Guilford, CT (US)

(72) Inventor: Stephanie Ann Highkin, Guilford, CT (US)

(21) Appl. No.: 16/947,143

(22) Filed: Jul. 21, 2020

(51) Int. Cl. A41D 19/015; A41D 19/00

(52) U.S. Cl. CPC A41D 19/01582; A41D 19/0013; A61H 2201/1635; A61H 2205/065; A61H 2201/165; A41D 19/0034

(57) ABSTRACT

A conjoined handwear is provided. The conjoined handwear has a first handwear and a second handwear, each handwear having a thumb opening, wherein the first and second handwear are joined in such a way that the thumb openings are adjacent to each other, thereby a guide may engage the first handwear while a patient engages the second handwear so that former can, by moving their own hand, influence the movement of the latter's hand during manual tasks.

### BACKGROUND OF THE INVENTION

The present invention relates to therapeutic and medical devices and, more particularly, conjoined hand wear having a pair of hand wear joined hand over hand, so that a first wearer can assist a second, simultaneous wearer with manual tasks. The second wearer may be a patient and the first wearer a caregiver, whereby the caregiver, by way of the conjoined hand wear, can assist the second wearer with moving their hand to do things such as handle food while eating.

The elderly, those with disorders (such as arthritis), the injured, the sick and others who have diminished or poor manual dexterity need assistance with basic life skills that require the use of one or more of their hands, such as feeding themselves. Furthermore, when these same individuals no longer have the language ability to orally communicate with, the inherent understanding of movement can be better than words when being assisted in such life skills.

As can be seen, there is a need for conjoined hand wear that enables a caretaker to assist another individual in using that individual's hand. Specifically, the conjoined hand wear embodied in the present invention enables said caretaker and said individual to simultaneously wear or engage the conjoined hand wear with a respective hand, whereby the former assists the latter in using their hand to, among other things, manipulate objects. For instance, the conjoined hand wear allows the caretaker to compensate for the individual's limited manual dexterity abilities.

Furthermore, such individuals understand the movement of eating and the resulting physical engagement in the eating/mealtime process that the present invention enables, whereby the present invention can be used as a physical and mental therapy device.

### SUMMARY OF THE INVENTION

In one aspect of the present invention, a conjoined handwear includes a first handwear and a second handwear each having a thumb opening, wherein the first and second handwear are joined in such a way that the thumb openings are adjacent to each other.

In another aspect of the present invention each handwear of the conjoined handwear includes a body extending between a proximal opening and a distal opening; and the thumb opening is through the body, wherein each handwear is dimensioned to receive a human hand in such a way that fingers of said human hand are received through the distal opening while a wrist of said human hand and a thumb of said human hand are simultaneously received through the proximal opening and the thumb opening, respectively, wherein each body is movable to a flat condition defining a bisecting edge bisecting the thumb opening in such a way that a first portion of the thumb opening occupies a first portion of said body while a second portion of the thumb opening occupies a second portion of the body, wherein the first and second portions are facing away from each other in the flat condition, and wherein the first and second handwear are joined along the bisecting edge, wherein the first and second handwear are movable about the bisecting edge between the flat condition and a folded condition.

In yet another aspect of the present invention, a method of assisting an individual with manual tasks includes the following: providing the above-mentioned conjoined handwear; receiving a guide hand of a guide by the first handwear; receiving an individual hand of the individual by the second handwear; and moving the guide hand to influence said individual hand.

These and other features, aspects and advantages of the present invention will become better understood with reference to the following drawings, description and claims.

### BRIEF DESCRIPTION OF THE DRAWINGS

FIG. 1A is a perspective view of an exemplary embodiment of the present invention, illustrating a folded position;

FIG. 1B is a perspective view of an exemplary embodiment of the present invention, illustrating a spread position;

FIG. 1C is a side elevation view of an exemplary embodiment of the present invention, shown in the folded position;

FIG. 2 is a perspective view of an exemplary embodiment of the present invention, shown fully engaged; and

FIG. 3 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a conjoined hand wear having a first handwear and a second handwear, each handwear having a thumb opening, wherein the first and second handwear are joined in such a way that the thumb openings are adjacent to each other, thereby a guide may engage the first handwear while a patient engages the second handwear so that former can, by moving their own hand, influence the movement of the latter's hand during manual tasks.

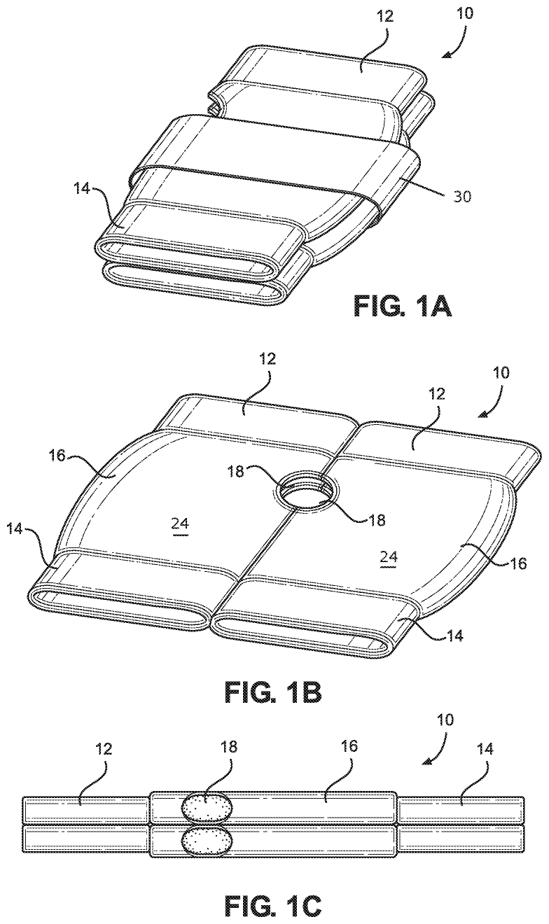

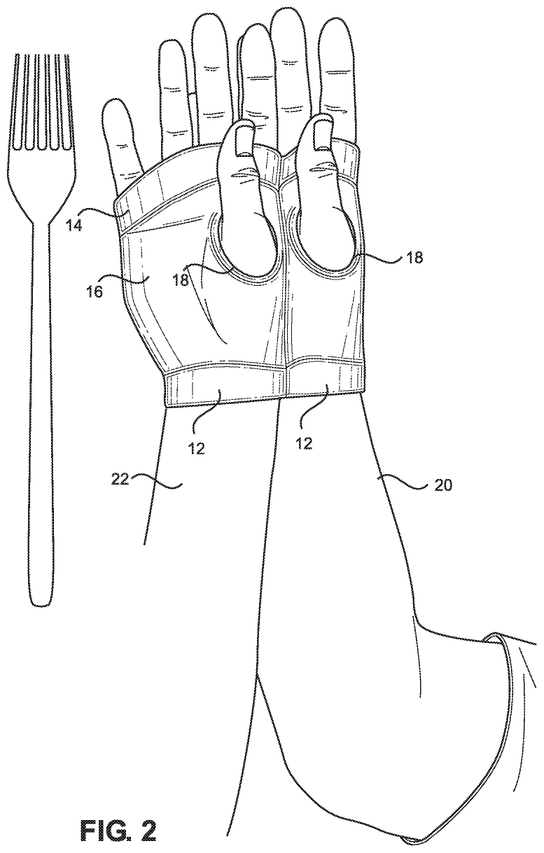

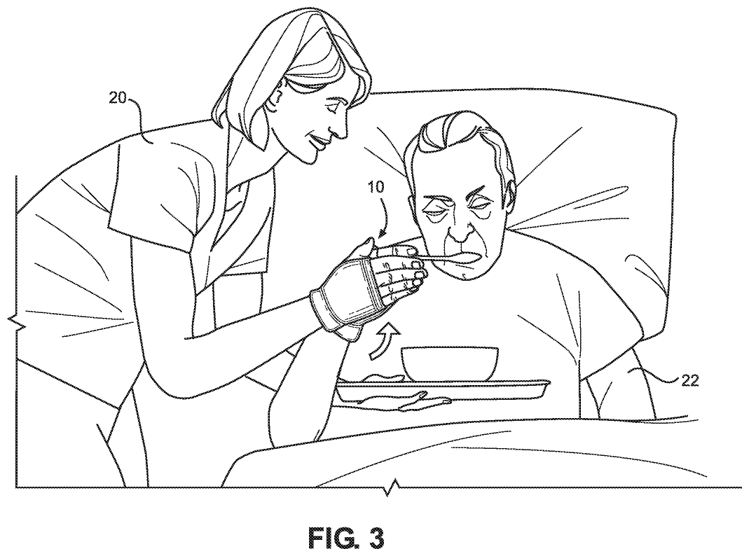

Referring now to FIGS. 1 through 3, the present invention may include a conjoined handwear 10. In certain embodiments, the conjoined handwear 10 may include a pair of hand wear 24 joined together along an attachment point. Each hand wear 24 may have a body 16 extending between a proximal opening 12 and a distal opening 14. Each body 16 may have a thumb opening 18. The pair of hand wear 24 may be joined together so that the two thumb openings 18 are adjacent to each other.

Each proximal opening 12 may be dimensioned to slidably receive a hand and wrist of a human user, each distal opening 14 may be dimensioned to slidably receive the fingers of the human user, and each thumb opening 18 may be dimensioned to slidably receive a thumb of a human user.

Even though not shown in the figures, it should be understood that the openings 12, 14, and 18—of one or both of the hand wears—may communicate to a respective cavity that is bounded in whole or in part. In other words, the proximal opening 12 may communicate with a sleeve that the wearer's arm is received in, the distal opening 14 may communicate to one or more cavities—e.g., one cavity defining a “mitten configuration” or a series of individual finger stalls defining a “glove configuration”—while the thumb opening 18 may communicate to the cavity of a thumb stall or the like.

The body 16 may be made from a material that is flexible and durable, whereby each piece of handwear 24 can assume a flat condition when not in use, as illustrated in FIGS. 1A-1C. The material may be hygienic, hypoallergenic, elastic, pliable and the like. In the flat condition, a bisecting edge 40 may be made to bisect the thumb opening 18—in other words, in the flat condition, a first portion of the thumb opening 18 may occupy a first portion of the body 16 while a second portion of the thumb opening 18 may occupy a second portion of the body 16, wherein the first and second portions are facing away from each other, as illustrated in FIG. 1B. A strap 30 may be dimensioned and adapted to store the conjoined handwear 10 in the folded position, as illustrated in FIG. 1A.

The pair of hand wear 24 of the conjoined handwear 10 may be joined along the bisecting edge 40 in such a way that the pair of hand wear 24 is movable between a folded position and a spread position, as illustrated in FIGS. 1A and 1B, respectively. In other words, the bisecting edge 40 is the attachment point. Though it should be understood that the pair of hand wear 24 may be joined along different portions and in different conditions or configurations, such as a tandem configuration with one hand wear 24 in front of the other, even though that is not shown in the drawings.

A method of using the present invention may include the following. The conjoined handwear 10 disclosed above may be provided. A guide 20 may slide their hand in the first of the pair of hand wear 24, while a patient 22 has their hand in the second of the pair of hand wear 24. In this hand-in-hand engagement, with one hand in front of the other, the guide 20 may guide the patient's hand movement. For example, during the patient's mealtime process the guide 20 may assist the patient 22 in guiding/bringing food to the patient's mouth, yet still allowing the individual his/her independence. The adjacency of the pair of thumb openings 18 facilitates the hand-in-had engagement, whereby the patient's hand and the caregiver's hand are moving in tandem, further diminishing the distinction between the hands, and thereby further promoting the patient's sense of independence.

Additionally, the present invention can be used in hospitals to help patients eat after procedures when they are not strong enough to feed themselves. The present invention may also be useful in nursing homes with elderly residents and dementia populations where the person no longer has the language ability but may understand motor cues and movement. In addition, the present invention may be used with young children learning the eating process as well as assisting special populations with disabilities.

It should be understood, of course, that the foregoing relates to exemplary embodiments of the invention and that modifications may be made without departing from the spirit and scope of the invention as set forth in the following claims.

What is claimed is:

1. A conjoined handwear, comprising:
a first handwear and a second handwear each having a thumb opening, wherein the first and second handwear are joined in such a way that the thumb openings are adjacent to each other.

2. The conjoined handwear of claim 1, wherein:
each hand wear comprises:
a body extending between a proximal opening and a distal opening; and
the thumb opening is through the body.

3. The conjoined handwear of claim 2, wherein each handwear is dimensioned to receive a human hand in such a way that fingers of said human hand are received through the distal opening while a wrist of said human hand and a thumb of said human hand are simultaneously received through the proximal opening and the thumb opening, respectively.

4. The conjoined handwear of claim 2, wherein each body is movable to a flat condition defining a bisecting edge bisecting the thumb opening in such a way that a first portion of the thumb opening occupies a first portion of said body while a second portion of the thumb opening occupies a second portion of the body, wherein the first and second portions are facing away from each other in the flat condition, and
wherein the first and second handwear are joined along the bisecting edge.

5. The conjoined handwear of claim 4, wherein the first and second handwear are movable about the bisecting edge between the flat condition and a folded condition.

6. A method of assisting an individual with manual tasks, comprising:
providing the conjoined handwear of claim 1;
receiving, by the first handwear, a guide hand of a guide;
receiving, by the second handwear, an individual hand of the individual; and
moving the guide hand to influence said individual hand.
